(19) United States
(12) Patent Application Publication
(10) Pub. No.: US 2019/0014738 A1
(43) Pub. Date: Jan. 17, 2019

(54) Catch Drawer Litter Box

(71) Applicants: Danny W. Akers, II, Silverthorne, CO (US); Kellie C. Akers, Silverthorne, CO (US)

(72) Inventors: Danny W. Akers, II, Silverthorne, CO (US); Kellie C. Akers, Silverthorne, CO (US)

(21) Appl. No.: 15/646,346

(22) Filed: Jul. 11, 2017

(51) Int. Cl. A01K 1/01

(52) U.S. Cl. CPC A01K 1/0107

(57) ABSTRACT

A catch drawer litter box for the recovery of litter and prevention of unwanted dispersal outside of a litter box. The catch drawer litter box generally includes a base and a cover. The base generally comprises a recovery region, a litter region, and a base divider separating these two regions. The litter region generally comprises a litter container configured for the receipt of litter comprising litter particles. Recovery region generally comprises a grate with openings large enough to allow passage of litter particles and a recovery drawer configured for removable deposition within the recovery region via an opening in the base. The recovery drawer is configured to receive at least a portion of the particles of litter that may pass through the openings in the grate.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a catch drawer litter box for the recovery of litter and prevention of unwanted dispersal outside of a litter box.

### Related Art

Any discussion of the related art throughout the specification should in no way be considered as an admission that such related art is widely known or forms part of common general knowledge in the field.

A litter box, which is sometimes referred to as a sandbox, is an indoor waste collection box for small animals. They are typically used inside homes and dwellings where the occupants have house cats as pets. As its name suggests, a litter box contains litter, which in this context, refers to a type of gravel that is well-suited to handle urine and animal feces. When used for house cats, the litter is generally referred to as cat litter. Ideally, a house cat will preferentially use a litter box for elimination of bodily waste. After elimination, the house cat will usually use its paws to kick or cover its waste products with litter.

Because this waste removal process includes a cat using its paws to cover its waste products, it may result in litter being propelled in arbitrary directions. Depending on the configuration of the litter box, this may result in litter being propelled outside of the litter box into the surrounding area. In addition, litter may adhere to the cat's paws during this process. Once the cat leaves the litter box, this litter will tend to be spread across areas along the cat's immediate path. Thus, such litter could be found some distance away from the litter box. Because used litter is likely to contain urine and feces, its spread may present a health and cleanliness problem.

In order to control the spread of litter throughout a home containing a house cat, various solutions have been used. In some cases, a litter box is placed within a covered enclosure with a single opening for entry and exit of a house cat. This type of litter box prevents the spread of litter in directions other than that of the entry opening. Although the spread of litter during the burial portion of the process is reduced, it may still occur in the direction of the entrance, which is adjacent to the litter. Moreover, this does nothing to prevent the spread of litter that may be attached to the cat's paws.

In other cases, adhesive pads may be placed near the entrance of the litter box. If the cat chooses to walk across the pad, some of the litter stuck to the cat's paws may be stuck to the adhesive pad. However, as it is used, the adhesive pad becomes less effective. Therefore, it must be monitored and replaced to maintain its effectiveness. Moreover, any litter that becomes stuck to the pad cannot be used. Thus, the litter in the litter box must be replaced more frequently. Moreover, some cats will avoid sticky surfaces, which means that the cat will avoid the adhesive pad making it ineffective, or worse, avoid the litter box entirely and find a new place for waste elimination that is less desirable for the owner.

What is needed is a litter box solution that prevents the spread of litter and recovers any litter that might otherwise spread throughout home.

### SUMMARY

An example embodiment is directed to a catch drawer litter box. The catch drawer litter box includes a base and a cover. The base generally comprises a recovery region, a litter region, and a base divider separating these two regions. The litter region generally comprises a litter container configured for the receipt of litter comprising litter particles. Recovery region generally comprises a grate with openings large enough to allow passage of litter particles and a recovery drawer configured for removable deposition within the recovery region via an opening in the base. The recovery drawer is configured to receive at least a portion of the particles of litter that may pass through the openings in the grate. The cover is generally configured to enclose the recovery region and the litter region of the base. The cover also includes an opening that is adjacent to the recovery region that is configured to allow passage of a cat to the litter by passing over the grate. In some embodiments, the top of cover is removable.

There has thus been outlined, rather broadly, some of the embodiments of the catch drawer litter box in order that the detailed description thereof may be better understood, and in order that the present contribution to the art may be better appreciated. There are additional embodiments of the catch drawer litter box that will be described hereinafter and that will form the subject matter of the claims appended hereto. In this respect, before explaining at least one embodiment of the catch drawer litter box in detail, it is to be understood that the catch drawer litter box is not limited in its application to the details of construction or to the arrangements of the components set forth in the following description or illustrated in the drawings. The catch drawer litter box is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a catch drawer litter box in accordance with an example embodiment.

FIG. 2 is a perspective view of a catch drawer litter box with its cover removed in accordance with an example embodiment.

FIG. 3 is an exploded view of a catch drawer litter box in accordance with an example embodiment.

FIG. 4 is a top-down view of the base of a catch drawer litter box in accordance with an example embodiment.

FIG. 5 is a cutaway view of the catch drawer litter box shown in FIG. 1.

FIG. 6 is a cutaway view of the catch drawer litter box shown in FIG. 1 illustrating a cat entering the catch drawer litter box.

FIG. 7 is a cutaway view of the catch drawer litter box shown in FIG. 1 illustrating a cat preparing to exit the catch drawer litter box.

FIG. 8 is a perspective view of a catch drawer litter box in accordance with an example embodiment illustrating the removal of a recovery drawer from the base of the catch drawer litter box.

FIG. 9 is a perspective view of a catch drawer litter box in accordance with an example embodiment illustrating the insertion of a recovery drawer into the base of the catch drawer litter box.

FIG. 10 is a perspective view of a catch drawer litter box comprised of a single structure in accordance with an example embodiment.

FIG. 11 is a perspective view of a catch drawer litter box with a door attached to the housing to selectively close the opening.

### DETAILED DESCRIPTION

### A. Overview

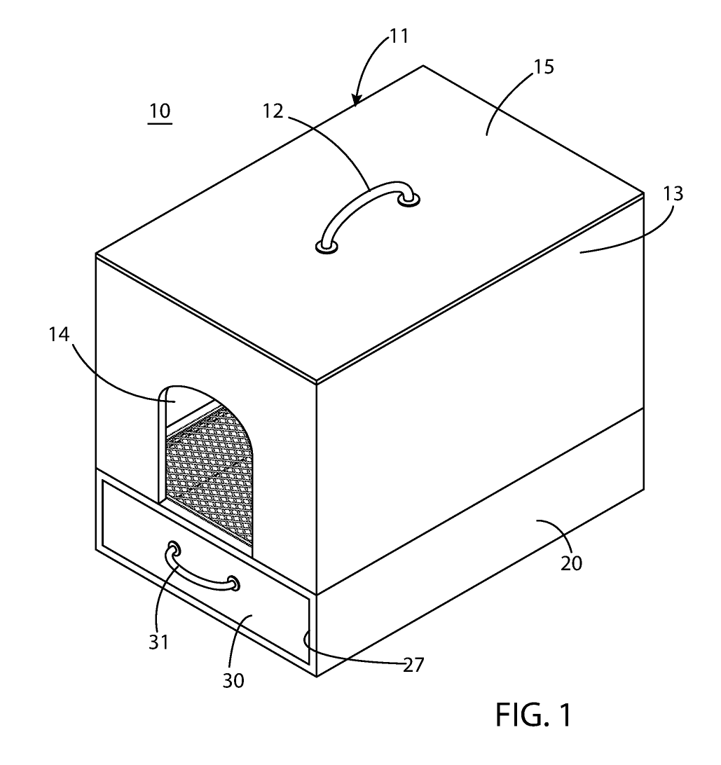

Turning now descriptively to the drawings, in which similar reference characters denote similar elements throughout the several views, FIGS. 1 through 11 illustrate a catch drawer litter box 10 including a base 20 and a cover 11. Base 20 generally comprises a recovery region 21, a litter region 23, and a base divider 26 separating these two regions. In some embodiments, base 20 may comprise a plurality of sides. The recovery side of base 20 is the side that is adjacent to recovery region 21 and is not adjacent to litter region 23. The litter side of base 20 is the side that is adjacent to litter region 23 and is not adjacent to recovery region 21. Common sides of base 20 include sides that are adjacent to both recovery region 21 and litter region 23. Litter region 23 generally comprises a litter container 24 configured for the receipt of litter 25 comprising litter particles. Recovery region 21 generally comprises a grate 22 comprising openings large enough to allow passage of particles of litter 25, and a recovery drawer 30 configured for removable deposition within recovery region 23 via an opening 27 in the recovery side of base 20. Recovery drawer 30 is configured for receipt of at least a portion of the particles of litter 25 that pass through the openings in grate 22. Litter box cover 11 is generally configured to enclose the recovery region 21 of base 20 and the litter region 23 of base 20 and comprises an opening 14 that is adjacent to the recovery region 21. Opening 14 is configured to allow passage of a cat 40 to litter 25 by passing over grate 22. In some embodiments, the top 15 of cover 11 is removably attached and includes a cover handle 12.

### B. Base

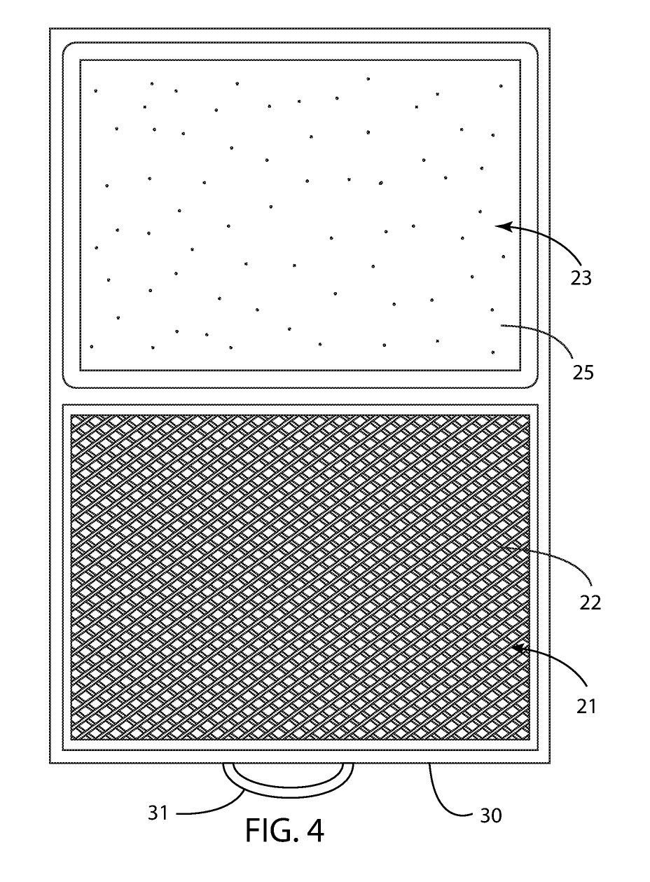

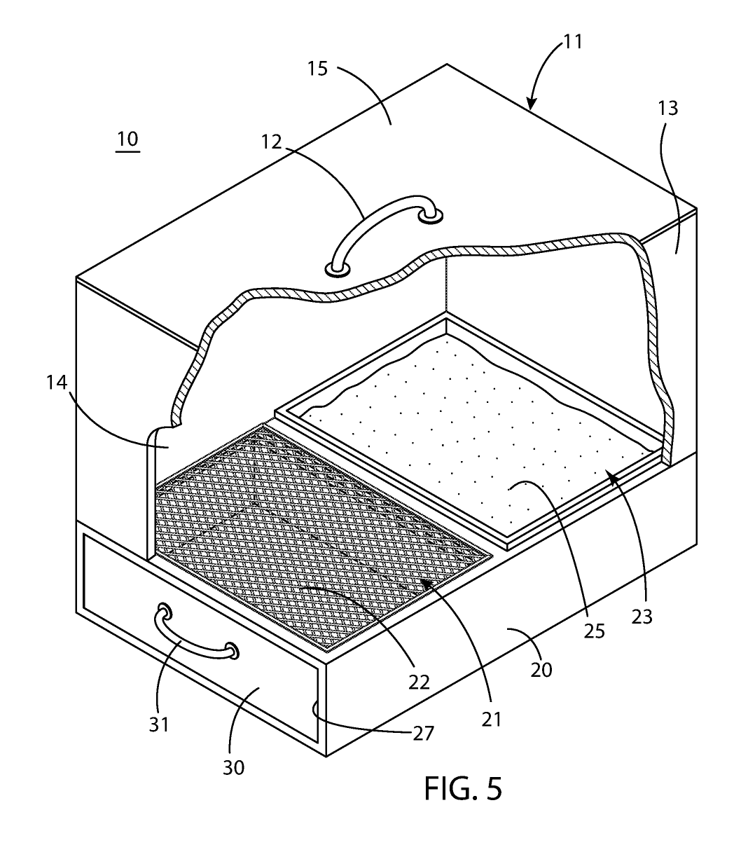

As best shown in FIGS. 4 and 5, a base 20 for use with a catch drawer litter box 10 generally comprises a recovery region 21 and a litter region 23. The recovery region 21 generally includes a grate 22 that is configured above a recovery drawer 30. The litter region 23 is generally configured to house a litter container 24. The litter container 24 is configured to receive and hold a quantity of litter 25 comprised of numerous particles. A base divider 26 may be used to separate the recovery region 21 from the litter region 23. The base 20 will generally include a recovery drawer opening 27 that is configured to receive a recovery drawer 30 that can be placed beneath grate 22. Typically, grate 22 and recovery drawer 30 are configured such that litter particles smaller than the openings in grate 22 will fall directly into recovery drawer 30. However, a plurality of grates 22 or a single grate 22 comprised of multiple layers may be used.

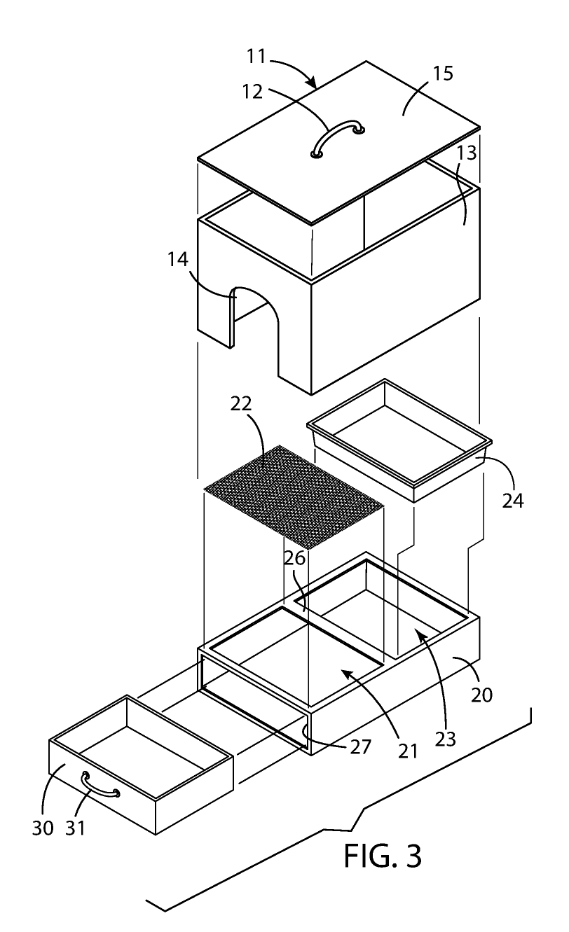

The litter region 23 of base 20 is configured in a manner that makes litter 25 available for waste elimination by cat 40. Litter 25 is generally held within a litter container 24. In some embodiments, litter container 24 is integrated into base 20. In other embodiments, as illustrated in FIG. 3, litter container 24 can be removed from base 20 for easier cleaning or replacement. Litter container 24 may also be comprised of multiple pieces that collectively hold litter 25. In some embodiments, litter container 24 may also comprise a removable liner that rests within litter container 24. In other embodiments, litter container 24 includes a filter than can be removed to quickly remove clumps of litter that form due to waste elimination by cat 40.

Although the base 20 shown in FIGS. 1 through 10 comprises a rectangular profile, other profiles are suitable for use with a catch drawer litter box 10. For example, base 20 may include an oval shape, an elongated hexagon, or an irregular egg shape.

### C. Recovery Drawer

A recovery drawer 30 for use with a catch drawer litter box 10 is generally configured to be removably disposed within base 20 and beneath grate 22. In general, recovery drawer 30 is configured to capture any particles of litter 25 that pass through grate 22. However, in some embodiments, grate 22 may partially rest upon an impervious surface such as a lip or border used to support grate 22 and define recovery region 21. In such an embodiment, particles of litter 25 may become trapped such that they do not enter recovery drawer 30. In general, recovery drawer 30 will abut base divider 26 when fully inserted into base 20.

In some embodiments of a catch drawer litter box 10, recovery drawer 30 comprises a portion of base 20, such that removable of the recovery drawer 30 removes at least a portion of the sides of base 20. In this type of embodiment, base 20 may comprise one or more posts or a frame without sides. Moreover, base divider 26 may be completely absent, or be comprised of a portion of recovery drawer 30. For example, the recovery drawer 30 may abut a litter container 24 directly rather than a base divider 26 that is a fixed feature of base 20.

Although the recovery drawer 30 shown in FIGS. 1 through 10 is configured for removable attachment via the side of base 20 that is furthest from litter container 24 (i.e., recovery side), recovery drawer 30 may also be configured for removal from one of the sides adjacent to litter container 24 (i.e., common side). For example, if the catch drawer litter box 10 is placed in a corner or adjacent to a wall, it may be advantageous for recovery drawer 30 to be configured for removable deposition into recovery region 23 via an alternate side of base 20.

### D. Litter Box Cover

In order to prevent the unwanted dispersal of litter 25 to surrounding areas as part of the waste elimination process, catch drawer litter box 10 will generally include a litter box cover 11. Litter box cover 11 is generally configured to enclose recovery region 21 and litter region 23 of base 20. In some embodiments, litter box cover 11 is comprised of a plurality of litter box sides 13, a litter box opening 14, a litter box top 15, and a cover handle 12. Litter box sides 13 and litter box top 15 prevent cat litter 25 from being dispersed in the areas surrounding the catch drawer litter box 10. Litter box sides 13 and litter box top 15 also provide privacy for cat 40 and concealment of litter 25 for the owner. Litter box opening 14 permits cat 40 to enter and exit the catch drawer litter box 10. The litter box opening 14 is generally configured such that cat 40 must pass over grate 22 in order to reach cat litter 25. However, in some embodiments, litter box opening 14 may have a different shape or location along litter box sides 13. For example, litter box opening 14 may be located on a corner rather than a side. In this type of embodiment, cat 40 may have to turn to the right or left in order to reach litter 25.

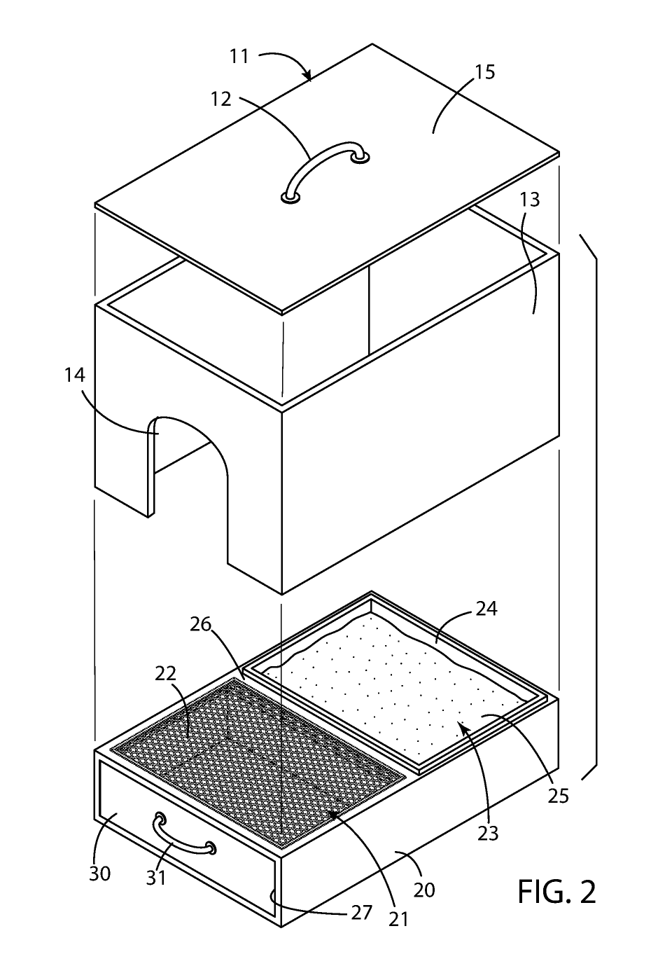

Litter box cover 11 may also include a cover handle 12 to aid in the temporary removal of litter box cover 11 or a portion thereof from base 20. In the example shown in FIGS. 2 and 3, a cover handle 12 is attached to litter box top 15, which is removable from litter box sides 13. In some embodiments, one or more cover handles 12 may be attached to litter box sides 13 in addition to or in lieu of a cover handle 12 attached to litter box top 15. In some embodiments, litter box sides 13 and litter box top 15 are configured to form a single unitary structure. In other embodiments, litter box cover 11 may comprise a single structure without clearly identifiable litter box sides 13 and litter box top 15. For example, if litter box cover 11 is comprised of a single unitary structure with a dome shape, there may be no meaningful distinction between litter box sides 13 and litter box top 15. However, even with a dome shaped litter box cover 11, an upper portion of the litter box cover 11 may be independently removable and considered to be litter box top 15. Similarly, a side portion of litter box cover 11 may be independently removable and considered to be a portion of litter box sides 13. In addition, a portion of litter box cover 11 may be hinged such that a temporary opening can be created without complete removal of that portion from litter box cover 11. In addition to surrounding recovery region 21 and litter region 23 while resting upon base 20, as shown in FIGS. 1 through 9, litter box cover 11 may also be configured to surround the entire base 20.

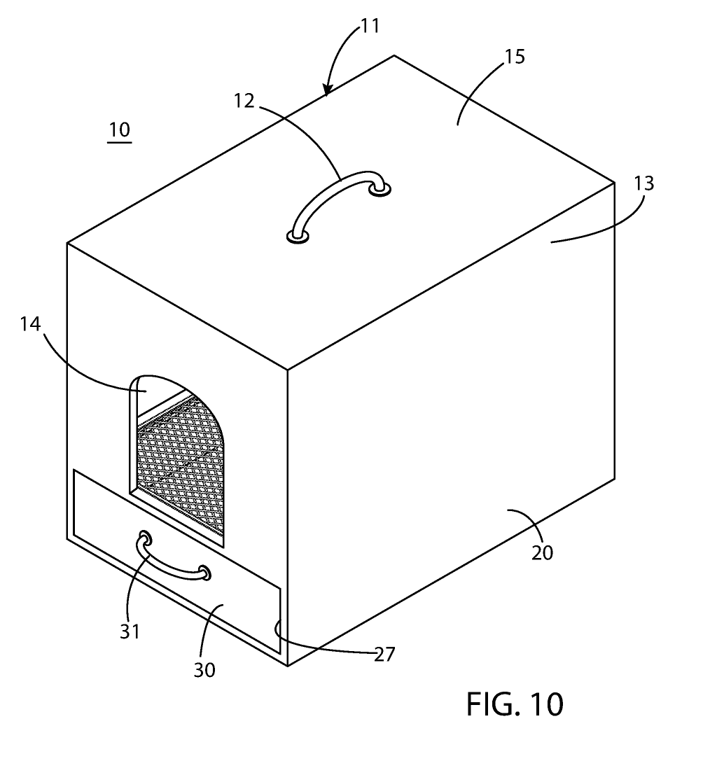

In addition to configurations of litter box cover 11, wherein the litter box cover 11 is independent of base 20, one or more portions of litter box cover 11 may be integrated into base 20. For example, litter box sides 13 may be integrated with base 20. In this embodiment, litter box top 15 may be the only removable portion of litter box cover 11. In other embodiments, litter box top 15 and a portion of litter box sides 13 are removable from litter box cover 11 as a single structure. In some embodiments, such as the one shown in FIG. 10, the entirety of litter box cover 11 may be integrated with base 20.

### E. Operation of Preferred Embodiment

In a preferred embodiment, with reference to FIG. 3, catch drawer litter box 10 is comprised of a base 20 and separate litter box cover 11, with the litter box cover 11 being comprised of litter box sides 13 and a separate litter box top 15. Base 20 comprises a recovery region 21 and a litter region 23 that are defined by four sides and a base divider 26. There is a separate litter container 24 that is configured to rest within litter region 23 of base 20, and a grate 22 that is configured to cover recovery region 21 of base 20. Base 20 also includes a recovery drawer 30 that is configured to be removably disposed within base 20 through an opening 27 so as to fit underneath grate 22.

The base 20 is placed in a preferred location for waste elimination. The grate 22 is put in place in the recovery region 21 of base 20. Litter container 24 is placed within the litter region 23 of base 20. A few inches of litter 25 is placed within litter container 24. Recovery drawer 30 is inserted into recovery drawer opening 27 of base 20, such that it rests underneath grate 22. The litter box sides 13 of litter box cover 11 are placed on base 20 so as to enclose recovery region 21 and litter region 23 with litter box opening 14 located near recovery region 21. Litter box top 15 is then placed on top of litter box sides 13 to complete the litter box cover 11 and fully enclose the space above of base 20. At this point, an exemplary catch drawer litter box 10 is in place for use by a cat 40.

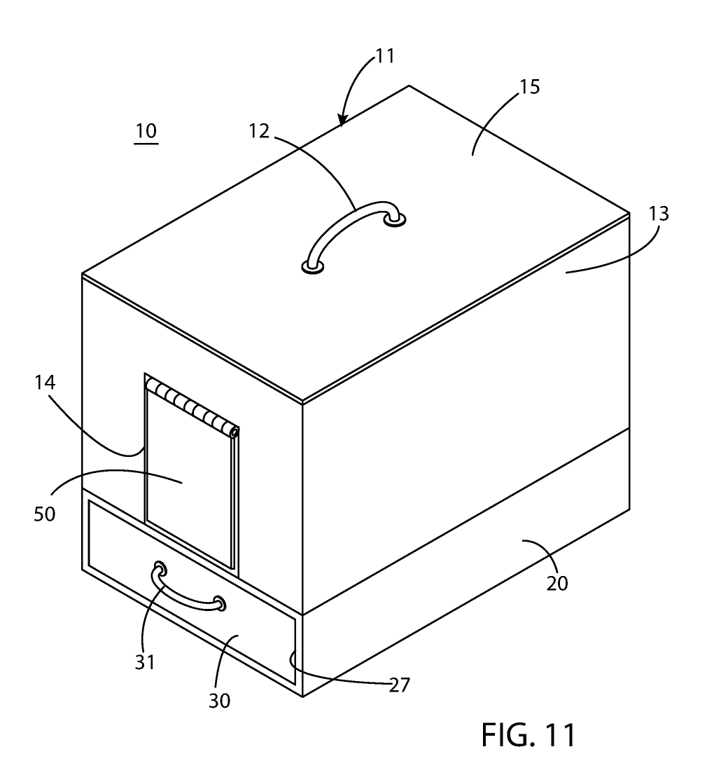

As shown in FIG. 11, a door or flapper 50 may be attached to the housing to selectively close the opening 14. The door or flapper 50 may be comprised of various types of doors or flappers commonly used in the pet industry to selectively close openings.

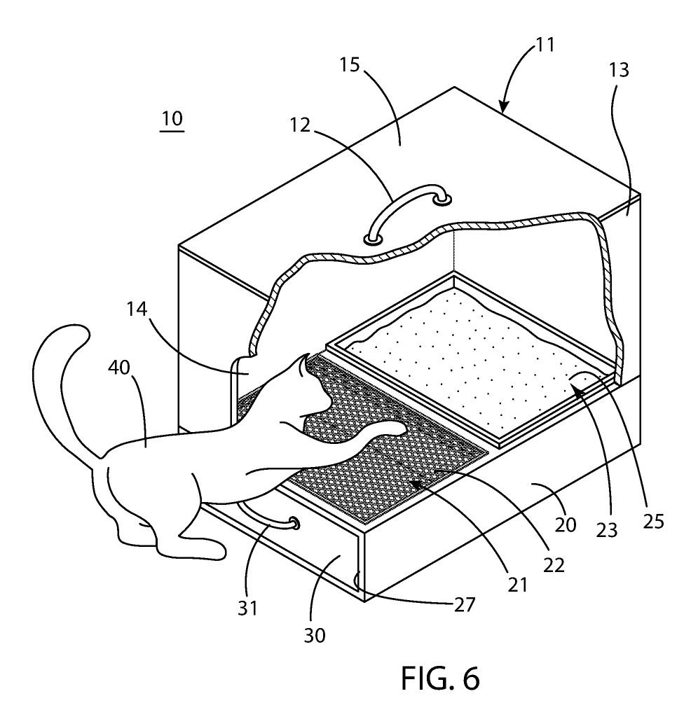

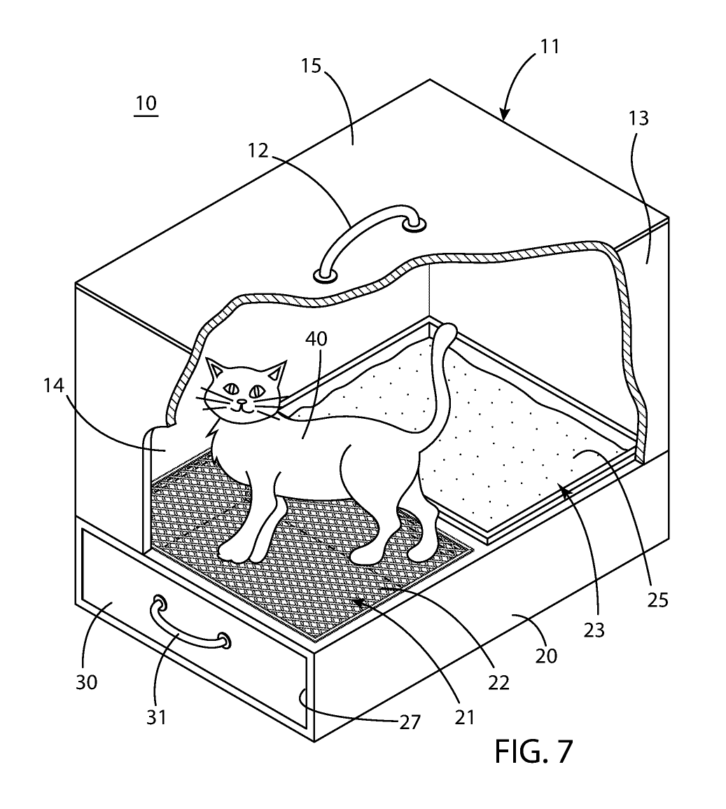

At various times after the catch drawer litter box 10 has been configured, cat 40 will enter via litter box opening 14, as shown in FIG. 6. Cat 40 will walk across grate 22 in recovery region 21 to reach the litter 25 that is held within the litter container 24 in litter region 23. Cat 40 will then use the litter 25 for purposes of waste elimination. This is generally followed by cat 40 attempting to bury its waste within the litter 25 held in litter container 24. This process of burying waste generally involves cat 40 using its paws to kick particles of litter 25 in the direction of the waste. Stray particles of litter 25 will generally bounce off litter box sides 13 and litter box top 15 and remain within the interior of the catch drawer litter box 10. Ideally, the majority of the stray particles of litter 25 will be reflected back into litter container 24. However, some of the particles will enter the recovery region 21, pass through the openings in grate 22, and land in recovery drawer 30. Still other particles of litter 25 will stick to the paws of cat 40. Ideally, very few particles of litter 25 will leave the catch drawer litter box 10 via opening 14. Having finished burying its waste, cat 40 will walk across grate 22 to exit catch drawer litter box 10 via opening 14, as shown in FIG. 7. The process of walking across grate 22 will generally cause any particles of litter 25 that are stuck to the paws of cat 40 to fall through the openings in grate 22 and into recovery drawer 30.

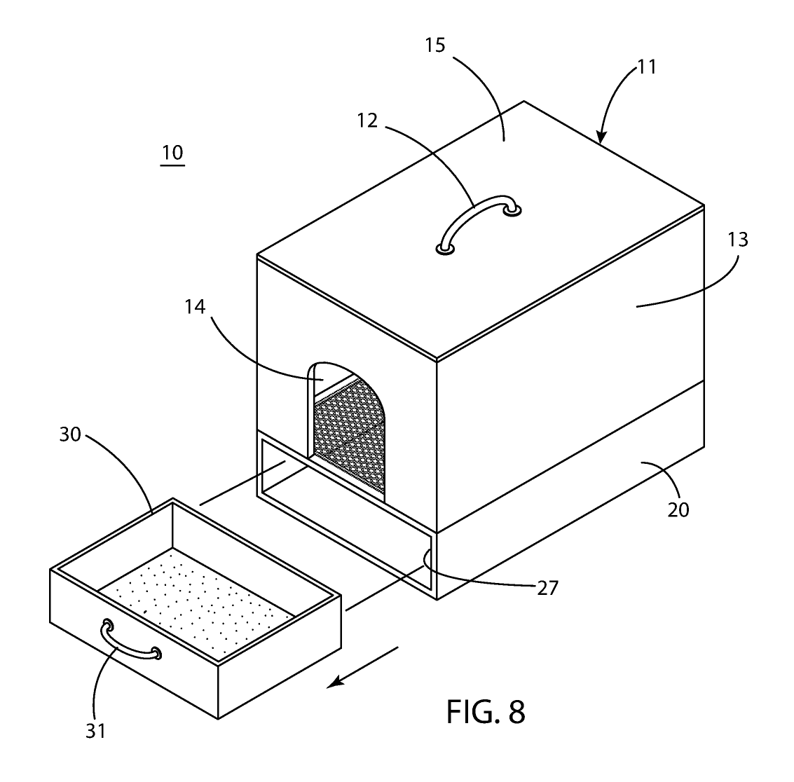

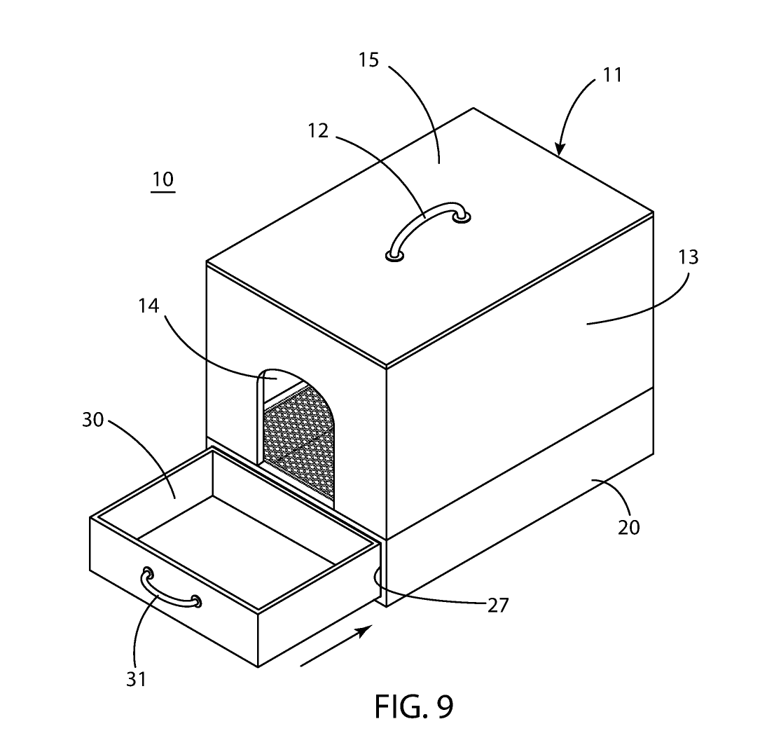

After one or more instances of waste elimination by cat 40, with the aid of drawer handle 31, recovery drawer 30 can be removed from base 20 as shown in FIG. 8. Recovery drawer 30 will generally include particles of litter 25 that have been kicked by cat 40 during waste burial and particles of litter 25 that have been scraped from the paws of cat 40 while exiting the catch drawer litter box 10. This recovered litter can either be discarded or returned to litter container 24 to replenish any litter 25 that may have been removed, such as during the cleaning of litter container 24. In some cases, recovery of litter 25 may occur immediately after litter container 24 has been cleaned. To the extent that litter 25 beyond that which was recovered in the recovery drawer 30 is needed, litter 25 can be replenished using fresh litter. After any particles of litter 25 in the recovery drawer 30 have been dealt with, recovery drawer 30 is returned to base 20 via recovery opening 27, as shown in FIG. 9. catch drawer litter box 10 is now available for additional use by cat 40.

Unless otherwise defined, all technical and scientific terms used herein have the same meaning as commonly understood by one of ordinary skill in the art to which this invention belongs. Although methods and materials similar to or equivalent to those described herein can be used in the practice or testing of the catch drawer litter box, suitable methods and materials are described above. All publications, patent applications, patents, and other references mentioned herein are incorporated by reference in their entirety to the extent allowed by applicable law and regulations. The catch drawer litter box may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A catch drawer litter box, comprising:
a base with a recovery region and a litter region;
a litter container configured within the litter region for the receipt of litter comprising litter particles;
a grate configured within the recovery region comprising openings large enough to allow passage of the litter particles;
a recovery drawer configured for removable deposition within the recovery region of the base, and configured for receipt of at least a portion of the litter particles that may pass through the openings in the grate; and
a cover configured to enclose the recovery region and litter region and comprising an opening adjacent to the recovery region that is configured to allow passage of a cat to the litter region by passing over the grate in the recovery region.

2. The catch drawer litter box of claim 1, wherein:
the base comprises a rectangular prism;
the cover comprises a rectangular prism having a top and four sides; and
at least a portion of the cover can be opened.

3. The catch drawer litter box of claim 2, wherein the top of the cover is removably attached and the cover can be opened by removal of the top.

4. The catch drawer litter box of claim 2, wherein the top of the cover is attached using a hinge and the cover can be opened by pivoting the top of the cover using the hinge.

5. The catch drawer litter box of claim 1, wherein the litter container is removably attached to the base.

6. The catch drawer litter box of claim 1, wherein the base and cover form a unitary structure.

7. The catch drawer litter box of claim 1, wherein the cover is comprised of a plurality of non-flat surfaces.

8. The catch drawer litter box of claim 7, wherein the cover is comprised a substantially flat and removable top face.

9. The catch drawer litter box of claim 8, wherein the base and the portions of the cover other than the substantially flat and removable top face form a unitary structure.

10. The catch drawer litter box of claim 6, wherein the grate is removably attached to the recovery region of the base.

11. A catch drawer litter box, comprising:
a base with a recovery region and a litter region;
a litter container configured within the litter region for the receipt of litter comprising litter particles;
a grate configured within the recovery region comprising openings large enough to allow passage of the litter particles;
a recovery drawer configured for removable deposition within the recovery region of the base, and configured for receipt of at least a portion of the litter particles that may pass through the openings in the grate;
a cover configured to enclose the recovery region and litter region comprising an opening adjacent to the recovery region that is configured to allow passage of a cat to the litter region by passing over the recovery region; and
wherein the cover comprises a removable top.

12. The catch drawer litter box of claim 11, wherein the cover is shaped as a rectangular prism.

13. The catch drawer litter box of claim 11, wherein the cover is fixedly attached to the base except for the top face.

14. The catch drawer litter box of claim 11, wherein the grate is fixedly attached to the recovery region of the base.

15. The catch drawer litter box of claim 11, wherein the base further comprises a base divider between the recovery region and the litter region.

16. The catch drawer litter box of claim 11, wherein the base is shaped as a rectangular prism and further comprises:
a recovery side that is adjacent to the recovery region of the base and is not adjacent to the litter region;
a litter side that is adjacent to the litter region that is not adjacent to the recovery region of the base; and
at least one common side that is adjacent to the litter region of the base and the recovery region of the base.

17. The catch drawer litter box of claim 16, wherein the recovery drawer is configured for removable deposition within the recovery region of the base via the recovery side of the base.

18. The catch drawer litter box of claim 16, wherein the recovery drawer is configured for removable deposition within the recovery region of the base via a common side of the base.

19. The catch drawer litter box of claim 11, wherein the grate is removably attached to the recovery drawer.

20. The catch drawer litter box of claim 11, wherein the recovery side of the base, the litter side of the base, and at least one common side are substantially flat.

21. A catch drawer litter box, comprising:
a base configured as a rectangular prism comprising;
a recovery region;
a litter region; and
a base divider separating the recovery region and the litter region;
a recovery side that is adjacent to the recovery region of the base and is not adjacent to the litter region of the base;
a litter side that is adjacent to the litter region of the base and is not adjacent to the recovery region of the base; and
two common sides that are adjacent to the litter region of the base and the recovery region of the base;
a litter container configured within the litter region for the receipt of litter comprising litter particles;
a grate configured within the recovery region comprising openings large enough to allow passage of the litter particles;
a recovery drawer configured for removable deposition within the recovery region of the base via the recovery side of the base, and configured for receipt of at least a portion of the litter particles that may pass through the openings in the grate;
a cover configured to enclose the recovery region and litter region comprising an opening adjacent to the recovery region that is configured to allow passage of a cat to the litter region by passing over the recovery region;
wherein the cover comprises a substantially-flat top face and four substantially-flat side faces that form a rectangular prism; and
wherein the top face is removably attached to the cover.
